(19) United States
(12) Patent Application Publication
(10) Pub. No.: US 2024/0204322 A1
(43) Pub. Date: Jun. 20, 2024

(54) A BATTERY CELL HOLDER

(71) Applicant: Upgrade Technology Engineering Ltd., Potters Bar (GB)

(72) Inventor: Christopher J. Hale, Potters Bar (GB)

(73) Assignee: Upgrade Technology Engineering Ltd., Potters Bar (GB)

(21) Appl. No.: 18/286,388

(22) PCT Filed: Apr. 4, 2022
(86) PCT No.: PCT/GB2022/050843

§ 371 Date: Oct. 11, 2023

(30) Foreign Application Priority Data
Apr. 12, 2021 (GB) 2105156.0

(51) Int. Cl. H01M 50/242; H01M 10/42; H01M 50/213; H01M 50/262; H01M 50/271; H01M 50/289; H01M 50/296; H01M 50/514; H01M 50/519; H01M 50/581; H01M 50/583

(52) U.S. Cl. CPC H01M 50/242; H01M 10/425; H01M 50/213; H01M 50/262; H01M 50/271; H01M 50/289; H01M 50/296; H01M 50/514; H01M 50/519; H01M 50/581; H01M 50/583; H01M 2010/4271

(57) ABSTRACT

A battery cell holder having terminal electrodes and a frame configured to support a plurality of battery cells in contact with the terminal electrodes. The frame having a base plate, a top plate, and at least one side support extending from the base plate to the top plate, the frame configured to support the plurality of battery cells between the base plate and top plate, wherein the terminal electrodes comprise a strip of conductive material configured to contact an electric terminal of one of the battery cells.

### FIELD OF THE INVENTION

The present invention relates to a battery cell holder configured to support a plurality of battery cells, for example for use in electric vehicles.

### BACKGROUND OF THE INVENTION

Battery packs are typically made up of a plurality of individual battery cells connected together in series and/or parallel. Battery packs may form battery systems designed for vehicles such as electric bikes or mopeds, and some applications may require a plurality of battery packs (or modules) connected in series and/or parallel to form larger battery systems, such as for large grid storage or EV's.

The capacity of a battery degrades through use and may be judged faulty once it falls to a specified percentage of its original capacity, which may be higher for some applications (such as 80% for an EV) and lower for other applications (such as energy storage), allowing re-use of batteries once they fall below capacity requirements for an current application but are still usable for other applications.

The re-use of batteries from a first life (EV) application to a second life (energy storage) application is still dependent on the state of health of individual battery cells within the battery. If the battery cells are all permanently fixed together as with traditional approaches such as welding or wire bonding, faulty or weak cells cannot be easily extracted or replaced.

The present invention provides a battery pack construction that enables cost effective assembly and disassembly to extract and replace cells. This allows core components to be re-used with replaced cells and allows removed cells to be tested and graded prior to re-use in second life application.

Since the battery cells are no longer permanently fixed together, it becomes important to ensure that the electrical connections to the battery cell terminals can withstand vibrations in normal use without disconnecting from one another. WO 2018/215725 A1 discloses elastomeric protrusions for urging conductors toward terminals at opposing ends of the battery cells to maintain electrical continuity under vibrations, however there is still room for further improvement.

### SUMMARY OF THE INVENTION

In accordance with a first aspect of the invention, there is provided a battery cell holder comprising terminal electrodes and a frame configured to support a plurality of battery cells in contact with the terminal electrodes, the frame comprising a base plate, a top plate, and at least one side support extending from the base plate to the top plate. The frame is configured to support the plurality of battery cells between the base plate and top plate such that each battery cell has an end adjacent the base plate, an end adjacent the top plate and a side extending between the ends and adjacent the at least one side support, wherein the terminal electrodes comprise one or more strips of conductive material that extend:
along the top plate for contacting an electric terminal of one of the ends of one of the battery cells, and
along the side support for contacting a further electric terminal of the side of a further one of the battery cells.

Vibrations have the most impact on electrical continuity when the vibrations occur in a direction that is normal to the contact surface. Since the strip(s) of conductive material connect to an electrical terminal at an end of the battery cell, for example a positive terminal, and connect to a further electric terminal of the side of a further one of the battery cells, for example a negative terminal, the contact surfaces between the strip(s) of conductive material and the different terminals of the battery cells are in different planes to one another, and so only one of those two contact surfaces will be significantly affected by any given direction of vibration.

There may be one strip of conductive material contacting the electrical terminal at the end of the battery cell and another strip of conductive material contacting the further electric terminal of the side of the further battery cell, however in a preferred embodiment one strip of conductive material contacts both the electrical terminal at the end of the battery cell and the further electric terminal of the side of the further battery cell, to electrically connect the battery cells in series with one another. Multiple ones of those strips of conductive material may be provided to connect multiple batteries in series, and other ones of the strips of conductive material may each contact the electrical terminals at the ends of two or more battery cells, and/or each contact the further electrical terminals at the sides of two or more battery cells, to connect the battery cells in series and parallel combinations.

Preferably, the strip(s) of conductive material contact the electrical terminal at the end of the battery cell in a first plane and the further electric terminal of the side of the further battery cell in a second plane, the planes being perpendicular to one another, which will normally be the case for cylindrical or rectangular battery cells.

In accordance with a second aspect of the invention, there is provided a battery cell holder comprising terminal electrodes and a frame configured to support a plurality of battery cells in contact with the terminal electrodes, the frame comprising a base plate, a top plate, and at least one side support extending from the base plate to the top plate, the frame configured to support the plurality of battery cells between the base plate and top plate, wherein the terminal electrodes comprise a strip of conductive material configured to contact an electric terminal of one of the battery cells, wherein a resiliently compressible element is provided between the strip of conductive material and the frame, and wherein the resiliently compressible element is provided with a magnet configured to magnetically attract the battery cell toward the strip of conductive material. The battery cell holder may be the same as the battery cell holder of the first aspect of the invention.

The resiliently compressible element helps to keep the electric terminal of the battery cell in contact with the strip of conductive material when the frame is vibrated by allowing some relative movement between the strip of conductive material and the frame. The magnet provided with the resiliently compressible attracts the battery cell towards the resiliently compressible element and the strip of conductive material, and so further reduces the risk of the battery cell disconnecting from the strip of conductive material as the frame is vibrated. Studies have demonstrated that a weak magnetic field should not impact on the cells performance, and should be sufficiently weak so as to not impact on any nearby electronics and have a very low field detectable outside of the battery cell holder. The resiliently compressible element may for example be an elastomeric element, which may be rubber.

The magnet may be embedded within a cavity defined by the resiliently compressible element, and the cavity may position the magnet inside the resiliently compressible element with the magnet closer to an external side of the resiliently compressible element that faces the strip of conductive material, than to an opposite external side of the resiliently compressible element that faces away from the strip of conductive material. This places the magnet closer to the battery cell and so increases the magnetic force attracting the electric terminal of the battery cell toward the strip of conductive material.

The strip of conductive material is preferably sufficiently flexible to flex into contact with the electric terminal of the battery cell under the magnetic attraction exerted by the magnet, so that when the battery cell moves in a direction away from the resiliently compressible element, the pull of the magnet toward the battery cell pushes the strip of conductive material to flex in the same direction, keeping 25 the strip of conductive material in contact with the electric terminal of the battery cell.

The frame may be configured to support the plurality of battery cells between the base plate and the top plate such that each battery cell has an end adjacent the base plate, an end adjacent the top plate and a side extending between the ends and adjacent the at least one side support. Therefore, a longitudinal axis of each battery cell may extend in a direction from the base plate to the top plate, parallel to the at least one side support.

The resiliently compressible element may be positioned on the top plate and be configured to push the strip of conductive material into engagement with the electric terminal at the end of the battery cell, or the resiliently compressible element may be positioned on the at least one side support and be configured to push the strip of conductive material into engagement with the electric terminal at the side of the battery cell.

There are typically a plurality of the strips of conductive material and a plurality of the resiliently compressible elements, and preferably the resiliently compressible elements are provided both on the top plate for pushing the strips of conductive material into engagement with electric terminals at the ends of the battery cells, and on the at least one side support for pushing strips of conductive material into engagement with the electric terminals at the sides of the battery cells.

The at least one side support may define a plurality of cavities extending from the top plate to the base plate, each cavity for receiving a respective one of the plurality of battery cells. The at least one side support may comprise one or more outer side supports at the periphery of the battery cell holder, and one or more inner side supports between the outer side supports, the outer and inner side supports together defining the plurality of cavities for receiving the battery cells.

The or each outer side support may comprise a channel configured to receive a respective ridge of the top plate, and the ridge in the channel may prevent the outer side support from flexing outwardly from the top plate. Preferably the channel of the outer side support comprises a chamfered side that is configured to engage a chamfered side of the ridge of the top plate, to maintain the outer side supports and the top plate in the correct positions relative to one another.

The at least one side support may define a respective slot for each cavity that receives a battery cell, each slot extending in a direction from the top plate towards the base plate, and the resiliently compressible elements may be strips that are slid into the slots and which are configured to push a respective strip of conductive material into the cavity and against the side of the battery cell, to contact the electric terminal at the side of the battery cell.

If desired then the magnets could be omitted from the resiliently compressible elements on the top plate and/or the resiliently compressible elements on the at least one side support. The combination of resiliently compressible elements on the top plate for pushing the strips of conductive material into engagement with electric terminals at the ends of the battery cells, and resiliently compressible elements on the at least one side support for pushing strips of conductive material into engagement with the electric terminals at the sides of the battery cells, could be relied upon to reduce the risk of vibrations interrupting the connections between the electric terminals and the strips of conductive material. This would still provide an improvement over using resiliently compressible elements at both opposing ends of each battery cell, since there is less freedom of movement for the battery cell when a resiliently compressible element is only provided at one of the ends of the battery cell compared to at both ends. Accordingly, the cavity for each battery cell may be provided with a resiliently compressible element at only one end of the cavity, and a resiliently compressible element at only one side of the cavity.

In accordance with a third aspect of the invention, there is provided a battery cell holder comprising terminal electrodes and a frame configured to support a plurality of battery cells in contact with the terminal electrodes, the frame comprising a base plate, a top plate, and at least one side support extending from the base plate to the top plate. The frame is configured to support the plurality of battery cells between the base plate and top plate such that each battery cell has an end adjacent the base plate and an end adjacent the top plate, wherein the terminal electrodes comprise a strip of conductive material configured to contact an electric terminal of a side of one of the battery cells between the ends of the battery cell, and wherein a thermistor is mounted on the strip of conductive material at the top plate. The battery cell holder may be the same as the battery cell holder of the first and/or second aspects of the invention.

The strip of conductive material can have a large area of contact with the side of the battery cell, and so can efficiently transfer heat from the battery cell up to the top plate, where there is space to fit a thermistor on the strip of conductive material to monitor the temperature of the battery cell.

A first portion of the strip of conductive material may have a first width and a second portion of the strip of conductive material may have a second width, the first width being wider than the second width, wherein the contact with the electric terminal and the mounted thermistor are within the first portion of the strip of conductive material. Accordingly, the strip of conductive material may be given a greater width than that required to carry the expected electrical current over the first portion between the contact with the electric terminal and the mounted thermistor, to improve heat transfer from the battery cell to the thermistor and enable a more accurate estimate of the temperature of the battery cell.

The strip of conductive material as referred to throughout herein is a strip of electrically conductive material, as will be apparent from its function as an electrical conductor. The strip of conductive material preferably also has a high thermal conductivity, both to help carry heat away from the battery cells to reduce the risk of overheating, and to transmit the heat from the battery cells to the thermistor.

At least one thermal conducting strip may also be added, contacting the side wall of the battery cell for the purpose of monitoring temperature. A thermistor may be mounted on each thermal conducting strip at the top plate. The thermal conducting strip only contacts one of the battery cells, and so is not typically used to conduct electricity between the battery cells.

In accordance with a fourth aspect of the invention, there is provided a battery cell holder comprising terminal electrodes and a frame configured to support a plurality of battery cells in contact with the terminal electrodes, the frame comprising a base plate, a top plate, and at least one side support extending from the base plate to the top plate. The frame is configured to support the plurality of battery cells between the base plate and top plate, wherein the terminal electrodes comprise a strip of conductive material configured to contact electric terminals of two of the battery cells. The strip of conductive material extends from one of the electric terminals to a lower surface of the top plate, through the top plate to an upper surface of the top plate, back through the top plate to the lower surface of the top plate, and to a further one of the electric terminals, and wherein a portion of the strip of conductive material on the top plate defines an electrical pad that is configured to connect to further electrical circuitry. The battery cell holder may be the same as the battery cell holder of the first, second and/or third aspects of the invention.

The top plate retains the battery cells in the battery cell holder and the upper surface of the top plate provides access to the strip of conductive material electrically connected between the two battery cells, allowing further circuitry to be connected to the strip of conductive material. The strip of conductive material may extend between electric terminals of the same polarity to one another, to define a parallel connection between the two battery cells, or the strip of conductive material may extend between electric terminals of different polarity to one another, to define a series connection between the two battery cells.

The terminal electrodes may comprise a plurality of the strips of conductive material that are configured to connect between the battery cells, and the upper surface of the top plate may provide access to the plurality of strips of conductive material, to allow the further circuitry to connect to multiple circuit nodes forming electrical connections between the batteries.

The battery cell holder may comprise a flex circuit substrate supporting the further electrical circuitry, the flex circuit substrate configured to overlay the top plate and to connect to the electrical pads of the strips of conductive material. The flex circuit substrate electrically connects the strips of conductive material to a battery management system that is configured to monitor the states of the battery cells, including their voltages or states of health, and so can signal when battery cell performance has fallen beneath minimum requirements. A flex circuit substrate is a very thin and flexible circuit substrate, often constituted by a thin layer of polymer having conductive tracks printed upon it, as is known in the art.

In accordance with a fifth aspect of the invention, there is provided a battery cell holder comprising terminal electrodes and a frame configured to support a plurality of battery cells in contact with the terminal electrodes, the frame comprising a base plate, a top plate, and at least one side support extending from the base plate to the top plate. The frame is configured to support the plurality of battery cells between the base plate and top plate, wherein the terminal electrodes comprise a strip of conductive material configured to contact electric terminals of two of the battery cells, and wherein the strip of conductive material comprises a portion of reduced cross-sectional area that is configured to act as a fuse in the event of excess electrical current flowing between the two battery cells. The battery cell holder may be the same as the battery cell holder of the first, second, third and/or fourth aspects of the invention.

The use of the strip of conductive material to define the fuse saves the need for extra fuse components and connections, reducing the cost of the battery cell holder. Should the strip of conductive material fuse, i.e. melt, in response to excessive current, then the strip of conductive material can be replaced with a new strip of conductive material to restore the functionality of the battery cell holder. The terminal electrodes preferably comprise a plurality of the strips of conductive material that are configured to connect between the battery cells, so that the battery cells can be connected together in series and/or parallel with fuses between them.

The strip of conductive material is preferably copper, both for its high electrical and thermal conductivity, however alternative electrical conductors could be used in alternative embodiments. The copper strip preferably has a thickness of less than 1.2 mm, so that it can easily flex to stay in contact with the electric terminals of the battery cells under vibrations.

In accordance with a sixth aspect of the invention, there is provided a battery cell holder comprising terminal electrodes and a frame configured to support a plurality of battery cells in contact with the terminal electrodes, the frame comprising a base plate, a top plate, and at least one side support extending from the base plate to the top plate. The frame is configured to support the plurality of battery cells between the base plate and top plate, wherein the terminal electrodes comprise a strip of conductive material configured to contact an electric terminal of one of the battery cells, wherein a resiliently compressible element is provided between the strip of conductive material and the frame, wherein the top plate is bolted or screwed to the at least one side support using a bolt or screw, and wherein a longitudinal axis of the bolt or screw is perpendicular to a direction extending through the resiliently compressible element from the frame to the strip of conductive material. The battery cell holder may be the same as the battery cell holder of the first, second, third, fourth and/or fifth aspects of the invention.

Since longitudinal axis of the bolt or screw is perpendicular to a direction extending through the resiliently compressible element from the frame to the strip of conductive material, the tensional force exerted by the bolt or screw has little, if any, impact on the state of compression of the resiliently compressible element between the frame and the strip of conductive material. Therefore the tightness to which the bolt or screw is done up will not significantly influence the amount of compression of the resiliently compressible element between the frame and the strip of conductive material, allowing the amount of compression of the resiliently compressible element to be accurately set based on the geometry of the frame, independently from how much the bolt or screw is tightened.

In accordance with a seventh aspect of the invention, there is provided a battery cell holder assembly comprising a first one and a second one of the battery cell holders of the sixth aspect, wherein an upper end of the at least one side support of the first battery cell holder overlaps an upper end of the at least one side support of the second battery cell holder, wherein the top plate of each battery cell holder comprises an upward protrusion, wherein the upward protrusion of the top plate of the first battery cell holder overlaps the upward protrusion of the top plate of the second battery cell holder, and wherein the bolt or screw passes through the upper ends of the at least one side supports of both the first and second battery holders at the overlap between the upper ends, and passes through the upward protrusions of the top plates of both the first and second battery holders at the overlap between the upward protrusions.

Therefore, the state of compression of the resiliently compressible element of both the first and second battery cell holders is independent of the tightness of the bolt or screw, and the bolt or screw functions to hold both the first and second battery cell holders together with one another.

In accordance with an eighth aspect of the invention, there is provided a battery pack comprising the battery cell holder of the first to sixth aspects or the battery cell holder assembly of the seventh aspect, the battery pack further comprising a plurality of battery cells supported between the base plate and top plate of the or each battery cell holder.

In accordance with a ninth aspect of the invention, there is provided an electric vehicle comprising the battery pack of the eighth aspect.

In accordance with a tenth aspect of the invention, there is provided a method of refurbishing the battery pack of the eighth aspect, comprising removing the top plate from the at least one side support, removing one or more of the battery cells and replacing with new cells, and replacing the top plate on the at least one side support. Therefore, when battery cells become defective the battery 20) packs can be disassembled and the defective cells replaced with new ones.

The word ‘strip’ as used herein takes its normal meaning, signifying an elongated shape having a length much greater than its width, for example the strip of conductive material may have a length of at least three times greater than its width.

Preferably the strip of conductive material has a width much greater than its thickness, for example a width of at least three times greater than its thickness. Keeping the thickness down maintains the flexibility of the strip of conductive material, and allowing the width to be greater than the thickness allows the strip of conductive material to carry a higher current without sacrificing the ability to bend and flex the strip of conductive material in the desired directions. The strip of conductive material is preferably a single piece of conductive material.

### BRIEF DESCRIPTION OF THE DRAWINGS

Embodiments of the invention will now be described by way of non-limiting example only and with reference to the accompanying drawings, in which:

FIG. 1 shows a schematic cross-sectional diagram through a battery cell holder according to an embodiment of the invention;

FIG. 2 shows a schematic diagram of the top of the battery cell holder of FIG. 1;

FIG. 3 shows a schematic diagram of the top of a battery cell holder similar to FIG. 2 and with a flex circuit substrate removed;

FIG. 4 shows a schematic diagram of the top of the battery cell holder of FIG. 3 and with a top plate additionally removed;

FIG. 5 shows a schematic perspective diagram of a strip of conductive material with resiliently compressible elements that is part of the battery cell holders of FIGS. 1 to 4;

FIG. 6 shows a schematic perspective diagram of an alternative strip of conductive material with resiliently compressible elements that could alternatively be implemented in the battery cell holders of FIGS. 1 to 4;

FIG. 7 shows a schematic perspective diagram of a further alternative strip of conductive material with resiliently compressible elements that could alternatively be implemented in the battery cell holders of FIGS. 1 to 4;

FIG. 8 shows a schematic cross-sectional diagram through a battery cell holder according to another embodiment of the invention;

FIG. 9 shows a schematic cross-sectional diagram of a battery cell holder assembly including two battery cell holders similar to those of FIG. 1;

FIG. 10 shows a schematic side view of the battery cell holder assembly of FIG. 9;

FIG. 11 shows a schematic diagram of an electric vehicle comprising a battery pack formed from two battery cell holders similar to those of FIG. 1; and

FIG. 12 shows a schematic flow diagram of the refurbishment of the battery pack of FIG. 11.

### DESCRIPTION OF THE PREFERRED EMBODIMENTS

The figures are not to scale, and same or similar reference signs denote same or similar features.

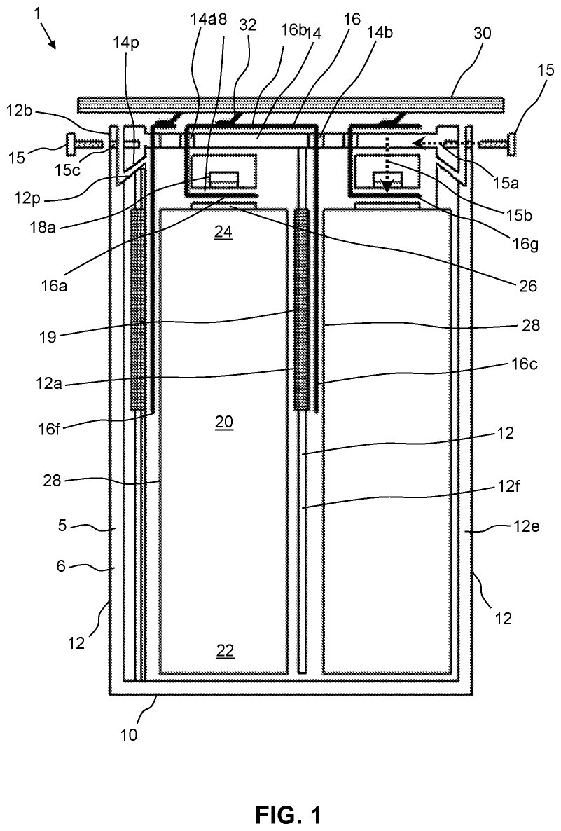

The schematic cross-sectional diagram of FIG. 1 shows a battery pack 1 comprising a battery cell holder 5 and two battery cells 20 (only one battery cell is labelled on FIG. 1 for clarity). The battery cell holder 5 comprises a frame 6, and the frame 6 comprises a base plate 10, side supports 12, and a top plate 14. The side supports 12 may include outer side supports 12e that are at the peripheral sides of the battery cell holder, and inner side supports 12f that are between the outer side supports 12e and between the battery cells 20. The base plate 10 and the outer side supports 12e may be integral with one another to define a housing, and for example be moulded from a plastics material. The top plate 14 and the inner side supports 12f may be integral with one another, and for example be moulded from a plastics material.

The outer side supports 12e may extend upwardly from the base plate 10 to the top plate 14, and the top plate 14 may be screwed to upper ends 12b of the outer side supports by screws 15. The upper ends 12b of the outer side supports may comprise a channel with a chamfered side 12p. The lower side of the top plate 14b may comprise a ridge that is configured to fit into the channel, and the ridge may have a chamfered side 14p that is configured to engage the chamfered side 12p of the channel. The ridge fits into the channel to prevent the upper ends 12b of the outer side supports 12e from flexing away from the battery cells 20. The base plate 10 and the outer side supports 12e, and a top plate 14 may together form the frame as an enclosure that encloses the battery cells 20.

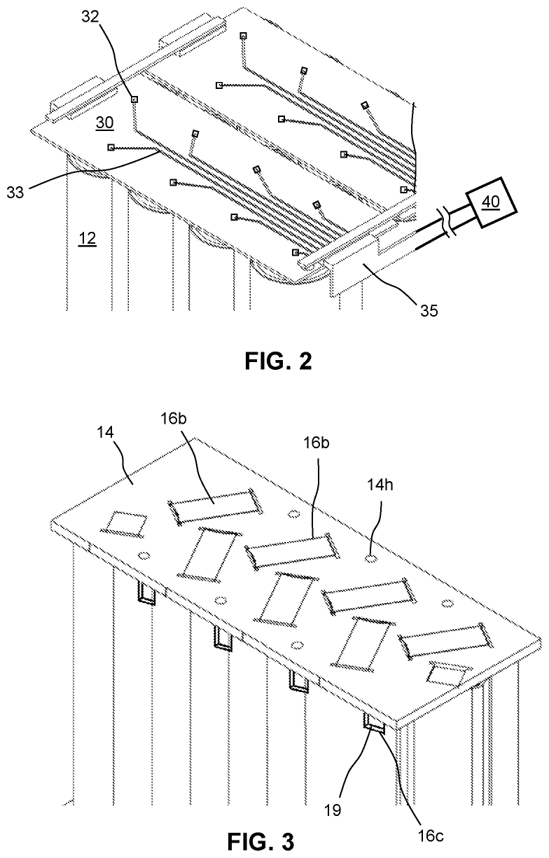

Each battery cell 20 may be cylindrical and have a lower end 22, an upper end 24, and a sidewall 28 that extends from the lower end to the upper end and defines the sides of the battery cell. The upper end 24 of the battery cell has a positive electric terminal 26, and the sidewall 28 is a negative electric terminal. The battery cell holder 5 also comprises strips of conductive material 16, 16f and 16g that connect between the battery cell terminals and a flexible circuit substrate having flexible circuitry 33 (see FIG. 2). Each battery cell may be formed by a metal can that defines the sidewall 28 and the negative electric terminal, and a top portion that has the positive electric terminal 26.

The battery cells 20 may be held by the inner side supports 12f extending from the top plate 14. The outer side supports 12e and the base plate 10 may together define a housing that can be slid over the battery cells and the inner side supports. Then, the upper ends of the outer side supports 12e may be screwed to the ends of the top plate 14, with the chamfered side 12p of the channel engaging the chamfered side 14p of the ridge to correctly position the housing and the top plate relative to one another.

Each strip of conductive material preferably has a length at least three times greater than its width, has a rectangular cross-section perpendicular to its length direction, and may be made of copper to provide high electrical conductivity and physical flexibility. The strips of conductive material 16, 16f and 16g may connect the two battery cells 20 in series with one another to the flexible circuitry 33. The strip of conductive material 16 may connect the positive and negative terminals of the two battery cells together, and may be provided with a connection 32 to the flexible circuitry 33, allowing the circuit node between the two battery cells to be monitored.

The strip of conductive material 16 has a first end 16a which may be bent beneath a resiliently compressible element in the form of an elastomeric element 18 to contact the positive electric terminal 26. The elastomeric element 18 may be mounted to the lower surface of the top plate 14 and have the shape of a cuboid, and may resiliently press the first end 16a of the strip of conductive material into contact with the positive electric terminal 26. The elastomeric element 18 may have a cavity in which a magnet 18a is held. The magnet 18a may be positioned inside the cuboid shape, closer to the lower external side that faces the strip of conductive material, than to the upper external side that faces towards the top plate 14, away from the strip of conductive material. The elastomeric element may be formed in two parts, one part that has a blind hole for receiving the magnet, and another part that seals the blind hole after the magnet has been inserted.

The magnet 18a pulls the positive electric terminal 26 and the first end 16a of the strip of conductive material together with one another, reducing the risk of the positive electric terminal 26 and the first end 16a separating from one another under vibrations and causing an open circuit.

The strip of conductive material 16 may extend from the positive electric terminal 26 to a lower surface of the top plate 14, through a hole 14a in the top plate to an upper surface of the top plate. A mid-section 16b of the strip of conductive material may extend along the upper surface of the top plate and constitute an electrical pad to which the connection 32 can be added to connect the strip of conductive material to the flexible circuitry 33. A second end 16c of the strip of conductive material may extend back through the top plate via a hole 14b in the top plate to the lower surface of the top plate, and to the negative electric terminal 28.

The second end 16c contacts the negative electric terminal 28 at the side of the battery cell, and so the strip of conductive material 16 connects the two battery cells together in series with one another. The side supports 12 define a respective slot 12a for each battery cell, each slot 12a extending downwardly from the upper end of the side supports where the top plate is located. Each 12a slot receives a resiliently compressible element in the form of an elastomeric strip 19. The elastomeric strip 19 is held in the slot and is positioned between the side support and the second end 16c of the strip of conductive material, thereby resiliently forcing the second end 16c into contact with the negative electric terminal 28 of the rightmost battery cell as viewed in FIG. 1. The elastomeric element 19 does not have any magnets, although it would be possible to include magnets similar to the magnets 18a in alternative embodiments if desired.

The area of contact of the first end 16a and the positive electric terminal 26 may be perpendicular to the area of contact of the second end 16c and the negative electric terminal 28, and so vibrations in a particular direction typically only affect one of those contact areas to any significant degree. If vibrations cause movement in a direction parallel to a plane of contact, then there is no significant risk of the contacting parts separating from one another under the vibrations. Since the lower ends 22 of the battery cells abut the bottom plate 10, there is no scope for the battery cells to move downwardly, and so the elastomeric elements 18 only have to accommodate upward movement of the battery cells from their neutral positions in which their lower ends 22 contact the bottom plate 10. The bottom plate 10 may be formed from a rigid plastics material.

Each battery cell 20 may contact the side support 12 on a first side of the battery cell and contact the second end 16c of the strip of conductive material on a second side of the battery cell opposite to the first cell, the second end 16c being pressed into contact with the battery cell by the elastomeric element 19. Therefore, under vibration the elastomeric element 19 only has to accommodate sideward movement of the battery cell from a neutral position in which the first side of the battery cell contacts the side support 12. The side support 12 may be formed from a rigid plastics material.

The top plate 14 may be connected to the outer side supports 12e by the screws 15. Specifically, the side supports 12e may have upper ends 12b that overlap with the ends of the top plate 14, and so the screws 15 can be screwed in sidewards along the longitudinal axis 15a of each screw, through the upper ends 12b and into the ends of the top plate 14. As can be appreciated from viewing FIG. 1, the degree to which the screws 15 are tightened has no significant impact on how much compression of the elastomeric elements 18 occurs between the frame and the battery cells, since the direction of the compression 15b between the frame and the battery cell is perpendicular to the longitudinal axis 15a of each screw. The amount of compression of the elastomeric elements 18 is set by the height at which the screw holes 15c are positioned in the upper ends 12b.

The schematic diagram of FIG. 2 shows a top view of the battery cell holder of FIG. 1, in which the flexible circuit substrate 30 and flexible circuitry 33 can be seen. The flexible circuit substrate 30 is laid on top of the top plate 14, and the flexible circuitry 33 is connected to the strip of conductive material 16 by making a solder joint 32 between the flexible circuitry 33 and the strip of conductive material 16. The flexible circuitry 33 comprises multiple joins to multiple strips of conductive material between multiple battery cells, allowing all of the circuit nodes between the battery cells of the battery pack to be monitored. The flexible circuitry is routed into a conduit 35 at an edge of the flexible circuit substrate 30, and is connected to a battery management system 40 which may be located on the battery pack or be remote from the battery pack.

The schematic diagram of FIG. 3 shows a top view of a battery cell holder similar to that shown in FIG. 2, but with the flexible circuit substrate 30 removed so that the top plate 14 is visible with the mid-sections 16b of the strips of conductive material visible on the top surface of the top plate 14. In addition, the battery holder of FIG. 3 may support eight battery cells rather than the sixteen battery cells supported by the battery cell holder of FIG. 2, and the battery cell holder of FIG. 3 may have holes 14h in the top surface of the top plate 14. The holes 14h are for receiving screws that screw into the upper parts of the side supports along a vertical longitudinal axis, rather than the holes 15c shown in FIG. 2 which allow screwing along a horizontal longitudinal axis. The screws that go through the holes 14h may also pass through the flexible circuit substrate 30 to hold the flexible circuit substrate to the top plate and side supports.

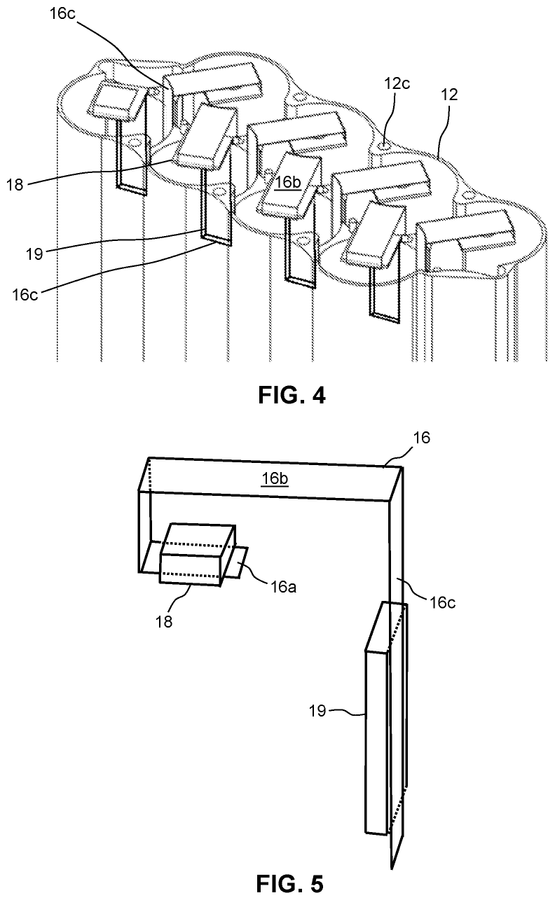

The schematic diagram of FIG. 4 shows a top view of the battery cell holder of FIG. 3 but with the top plate 14 removed, so that the shapes of the strips of conductive material 16 and the elastomeric elements 18 can be better seen. Also visible are screw holes 12c in the tops of the side supports, which may receive the screws that go through the holes 14h in FIG. 3, to secure the flexible circuit substrate 30 and the top plate 14 to the side supports 12.

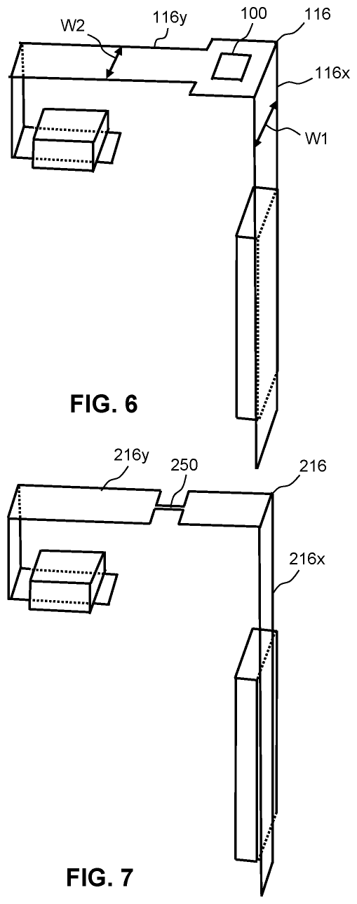

The schematic diagram of FIG. 5 shows the strip of conductive material 16 in isolation from the rest of the battery cell holder, along with the elastomeric elements 18 and 19. The strip of conductive material 16 has a rectangular cross section with a constant width and thickness along the whole of the length of the strip of conductive material. However, in further embodiments the widths and/or thicknesses of the strips can vary along their lengths, as will now be described with reference to FIG. 6 and FIG. 7.

FIG. 6 shows a schematic diagram of a strip of conductive material 116 that could be used in place of the strip of conductive material 16. The strip of conductive material 116 may have a first portion 116x that extends from the side of the battery cell to the top plate 14, and a second portion 116y that extends from the first portion to the top of an adjacent battery cell. The first portion 116x may have a first width W1 and the second portion may have a second width W2, the first width W1 being greater than the second width W2. The first portion may extend all the way from the second portion to the end of the strip and have the width W1 for substantially all of that extension, and the second portion may extend all the way from the first portion to the other end of the strip and have the width W2 for substantially all of that extension.

A thermistor 100 may be mounted on the strip of conductive material where the conductive material extends over the top plate, within the mid-section and the first portion 116x of the strip of conductive material. The thermistor 100 may then be connected to circuitry on a flexible circuit substrate similar to the flexible circuit substrate 30, and that circuitry may be connected to a battery management system to monitor the temperatures of all the battery cells.

The second width W2 is sufficient to carry all of the anticipated current through the strip of conductive material 116 without overheating, and the first width W1 is made greater than the second width W2 to increase the efficiency of heat transfer from the side of the battery cell to the thermistor 100. The thickness of the first portion 116x may also be greater than the thickness of the second portion 116y to increase heat transfer to the thermistor.

It would also be possible to use strips of conductive material similar to 116 but which did not necessarily carry any electricity and were purely designed to monitor the temperatures of the battery cells. For example, the second portion 116y could be entirely truncated from the strip 116 so that only the first portion 116x remained, the first portion 116 contacting the side 28 of the battery cell and transferring heat therefrom to the thermistor 100.

FIG. 7 shows a schematic diagram of another strip of conductive material 216 that could be used in place of the strip of conductive material 16. The strip of conductive material 216 may comprise a portion of reduced cross-sectional area 250 that will act as a fuse and melt in the event of excess electrical current flowing between the two battery cells. The fuse 250 may be positioned in the mid-section of the strip of conductive material, between the two end portions 216x and 216y. However, the fuse 250 could alternatively be positioned anywhere between the areas of contact of the strip of conductive material with the electric terminals of the battery cells. The fuse 250 could also be incorporated into the first or second portions 116x or 116y of the strip of conductive material 116 shown in FIG. 6.

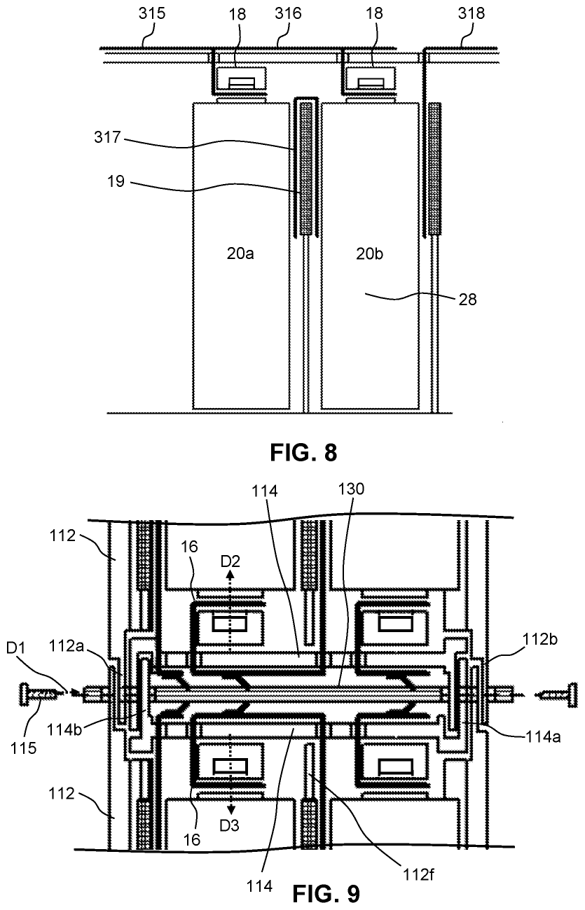

FIG. 8 shows a schematic cross-sectional diagram through a battery cell holder according to another embodiment of the invention, which is the same as the embodiments discussed above except for that the strips of conductive material are configured to connect the battery cells in parallel with one another rather than series. A strip of conductive material 316 connects the positive electric terminals together and is connected to a positive output electrode 315. A strip of conductive material 317 connects the negative electric terminals together. A strip of conductive material 318 provides a negative output electrode, which is electrically connected to the strip of conductive material 317 via the conductive side 28 of the battery cell. It is also possible to connect subsets of the battery cells with one another in parallel and connect the subsets with one another in series using the conductive strips to form various battery cell circuit configurations.

The schematic cross-sectional diagram of FIG. 9 shows a battery cell holder assembly comprising two battery cell holders similar to those shown in FIG. 1. The two battery cell holders may be the same as one another and each have side supports 112 connected to a top plate 114, similar to the side supports 12 and top plates 14 previously described. A flexible circuit substrate 130 may be positioned between the top plates 14 for making connections to the strips of conductive material 16.

Each battery cell holder has a side support with an upper end 112a at one side of the battery holder, and a side support with an upper end 112b at an opposite side of the batter cell holder. The upper end 112b is positioned further outwardly from the battery cell holder than the upper end 112a, and so when the two battery cells holders are abutted together as shown the upper end 112a of each battery cell holder overlaps the upper ends 112b of the other battery cell holder.

Each top plate 114 has an upward protrusion 114a at one side of the battery holder, and an upward protrusion 114b at an opposite side of the batter cell holder. The upward protrusion 114a is positioned further outwardly from the battery cell holder than the upward protrusion 114b, and so when the two battery cells holders are abutted together as shown the upward protrusion 114a of each battery cell holder overlaps the upward protrusion 114b of the other battery cell holder.

The two battery holders and their top plates are held together by screws 115 at either side of the battery cell holders. Each screw passes through the overlapping upper portions 112a and 112b, and also through the overlapping upper protrusions 114a and 114b, in a longitudinal direction D1 that is parallel to the directions D2 and D3 that the elastomeric elements are compressed in. Therefore, the state of compression of the elastomeric elements is independent of the tightness of the screws, and the screws perform the dual function of both securing the top plates 114 to the side supports 112 and securing the two battery cell holders to one another.

It would also be possible to provide the upper ends of the side supports with channels for receiving ridges of the top plates, in a similar manner to the channels and ridges discussed above in relation to FIG. 1. The side supports may comprise an inner side support 112f between the side supports 112, and the inner side support 112f may be integrally formed with the base plate 10. However, in an alternate embodiment it would be possible to form the inner side support 112f integrally with the top plate 114, similar to the inner side support 12e discussed above in relation to FIG. 1.

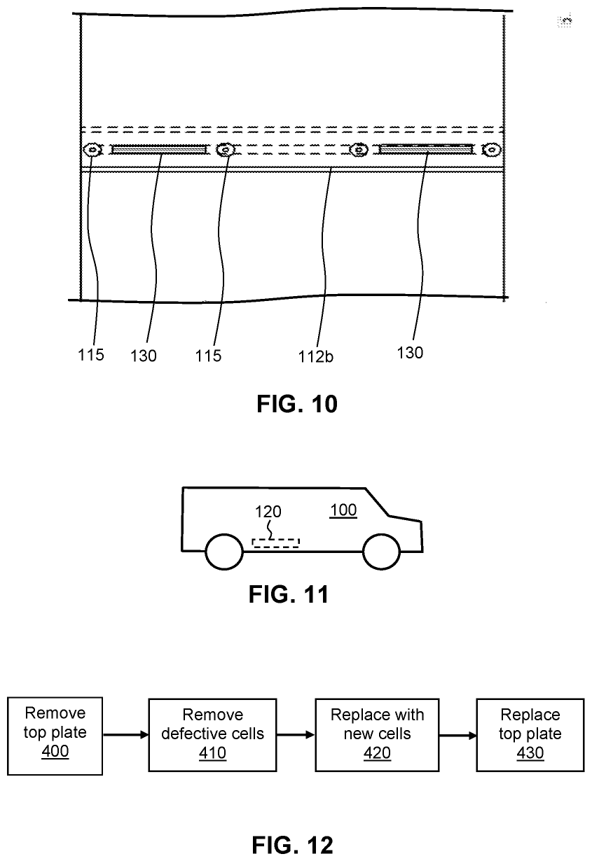

FIG. 10 shows a schematic side view of the battery cell holder assembly, taken looking in towards the right side of FIG. 9. It can be seen how the screws 115 are positioned intermittently along the side of the battery cell holder assembly, with the flexible circuit substrate 130 extending out from between the two battery cell holders at positions in between the screws 115, allowing connection of further electric circuitry to the flexible circuit substrate.

FIG. 11 shows a schematic diagram of an electric vehicle 100 comprising a battery pack 120 formed from battery cell holder assembly of FIG. 9 and a plurality of battery cells. The battery pack 100 delivers power to drive one or more motors of the electric vehicle to drive the vehicle forward. In this example the electric vehicle 100 is a van, however other types of electric vehicle such as cars or bikes could alternatively be implemented.

FIG. 12 shows a schematic flow diagram of the refurbishment of the battery pack 120. Once it has been determined that one of more battery cells of the battery pack are defective and need to be replaced, for example after a predetermined period of use of the battery pack, or in response to signals from a battery management system, the screws 115 may be undone in a step 400 to release the battery cell holders from one another, and to release the top plates 114 from the side supports 112. In an embodiment where inner side supports are permanently connected or integrally formed with the top plate, only the outer side supports are released from the top plate, rather than all of the side supports.

The defective battery cells may then be slid out from their cavities in a step 410, and either recycled or re-used in another less demanding context such as energy storage. The removed battery cells may then be replaced with new battery cells in a step 420. In a final step 430, the top plates 114 may be placed back onto the side supports 112 and the battery cell holders orientated to abut one another again, so that the screws 115 can be re-inserted and tightened to hold the battery cell holders together and to fix the top plates to the side supports.

Many other variations of the described embodiments falling within the scope of the invention will be apparent to those skilled in the art.

What is claimed:

1. A battery cell holder comprising terminal electrodes and a frame configured to support a plurality of battery cells in contact with the terminal electrodes, the frame comprising a base plate, a top plate, and at least one side support extending from the base plate to the top plate, the frame configured to support the plurality of battery cells between the base plate and top plate such that each battery cell has an end adjacent the base plate, an end adjacent the top plate and a side extending between the ends and adjacent the at least one side support, wherein the terminal electrodes comprise a strip of conductive material that extends:
along the top plate for contacting an electric terminal of one of the ends of one of the battery cells, and
along the side support for contacting a further electric terminal of the side of a further one of the battery cells.

2. The battery cell holder of claim 1, wherein a thermistor is mounted on the strip of conductive material at the top plate.

3. The battery cell holder of claim 2, wherein the strip of conductive material comprises a first portion of the strip of conductive material having a first width and a second portion of the strip of conductive material having a second width, the first width being wider than the second width, wherein the contact with the electric terminal and the mounted thermistor are within the first portion of the strip of conductive material.

4. The battery cell holder of claim 1, wherein the strip of conductive material extends from one of the electric terminals to a lower surface of the top plate, through the top plate to an upper surface of the top plate, back through the top plate to the lower surface of the top plate, and to the other one of the electric terminals, and wherein a portion of the strip of conductive material on the top plate defines an electrical pad that is configured to connect to further electrical circuitry.

5. The battery cell holder of claim 4, wherein the battery cell holder comprises a flex circuit substrate supporting the further electrical circuitry, the flex circuit substrate configured to overlay the top plate and to connect to the electrical pad of the strip of conductive material and to also connect to electrical pads of further ones of the strip of conductive material.

6. The battery cell holder of claim 5, wherein the flex circuit substrate electrically connects the strips of conductive material to a battery management system that is configured to monitor the states of the battery cells.

7. The battery cell holder of claim 1, wherein the strip of conductive material comprises a portion of reduced cross-sectional area that is configured to act as a fuse in the event of excess electrical current flowing between the two battery cells.

8. The battery cell holder of claim 1, wherein a resiliently compressible element is provided between the strip of conductive material and the frame, wherein the top plate is bolted or screwed to the at least one side support using a bolt or screw, and wherein a longitudinal axis of the bolt or screw is perpendicular to a direction extending through the resiliently compressible element from the frame to the strip of conductive material.

9. A battery cell holder comprising terminal electrodes and a frame configured to support a plurality of battery cells in contact with the terminal electrodes, the frame comprising a base plate, a top plate, and at least one side support extending from the base plate to the top plate, the frame configured to support the plurality of battery cells between the base plate and top plate, wherein the terminal electrodes comprise a strip of conductive material configured to contact an electric terminal of one of the battery cells, wherein a resiliently compressible element is provided between the strip of conductive material and the frame, and wherein the resiliently compressible element is provided with a magnet configured to magnetically attract the battery cell toward the strip of conductive material.

10. The battery cell holder of claim 9, wherein the magnet is embedded within a cavity defined by the resiliently compressible element.

11. The battery cell holder of claim 10, wherein the cavity positions the magnet inside the resiliently compressible element with the magnet closer to an external side of the resiliently compressible element that faces the conductive strip, than to an opposite external side of the resiliently compressible element that faces away from the conductive strip.

12. The battery cell holder of claim 9, wherein the strip of conductive material is configured to flex into contact with the electric terminal of the battery cell under the magnetic attraction exerted by the magnet.

13. The battery cell holder of claim 9, wherein the frame is configured to support the plurality of battery cells between the base plate and top plate such that each battery cell has an end adjacent the base plate, an end adjacent the top plate and a side extending between the ends and adjacent the at least one side support.

14. The battery cell holder of claim 13, wherein the resiliently compressible element is positioned on the top plate and is configured to push the strip of conductive material into engagement with the electric terminal at the end of the battery cell.

15. The battery cell holder of claim 14, wherein the resiliently compressible element is positioned on the at least one side support and is configured to push the strip of conductive material into engagement with the electric terminal at the side of the battery cell.

16. The battery cell holder of claim 15, wherein the strip of conductive material is further configured to contact a further electric terminal at the side of a further one of the battery cells, the battery cell holder comprising a further resiliently compressible element between the strip of conductive material and the frame, the further resiliently compressible element being positioned on the at least one side support and configured to push the strip of conductive material into engagement with the further electric terminal at the side of the further one of the battery cells.

17. The battery cell holder of claim 9, wherein the resiliently compressible element is an elastomeric element, for example rubber.

18. The battery cell holder of claim 9, wherein the at least one side support comprises a channel configured to receive a respective ridge of the top plate, wherein the channel comprises a chamfered side that is configured to engage a chamfered side of the ridge of the top plate.

19. The battery cell holder of claim 9, wherein the at least one side support comprises one or more outer side supports at the periphery of the battery cell holder, and one or more inner side supports between the outer side supports, the outer and inner side supports together defining a plurality of cavities for receiving the battery cells.

20. A battery cell holder assembly comprising an upper end of at least one side support of a first battery cell holder overlapping an upper end of the at least one side support of a second battery cell holder, wherein a top plate of each battery cell holder comprises an upward protrusion, wherein an upward protrusion of a top plate of the first battery cell holder overlaps the upward protrusion of a top plate of the second battery cell holder, and wherein a fastener passes through upper ends of the at least one side supports of both the first and second battery holders at the overlap between the upper ends, and passes through the upward protrusions of the top plates of both the first and second battery holders at the overlap between the upward protrusions.
